(19) United States
(12) Patent Application Publication
(10) Pub. No.: US 2024/0415711 A1
(43) Pub. Date: Dec. 19, 2024

(54) WHEELCHAIR AND CHAIR FRAME

(71) Applicant: DIETZ POWER B.V., Helmond (NL)

(72) Inventors: Stefan HENDRIKS, Helmond (NL); Sjoerd Noud Anne LINTERMANS, Helmond (NL)

(21) Appl. No.: 18/705,205

(22) PCT Filed: Oct. 26, 2022
(86) PCT No.: PCT/IB2022/060290

§ 371 Date: Apr. 26, 2024

(30) Foreign Application Priority Data
Oct. 28, 2021 (NL) 2029540

(51) Int. Cl. A61G 5/10; A61G 5/04

(52) U.S. Cl. CPC A61G 5/1056; A61G 5/04

(57) ABSTRACT

A wheelchair comprises a chassis (10) with a chair frame (20) thereon. The chair frame comprises a base frame (21) and a back frame (30) connected pivotally thereto. A first actuator (25) is arranged operatively between the base frame (21) and the back frame (30). The back frame (30) comprises a first part (31) which is connected to the base frame, and a second part (32) which carries a back cushion (23). Both parts (31, 32) are axially displaceable relative to each other. For this purpose the back frame (30) comprises a further actuator (35) which is arranged operatively between the first part (31) and the second part (32) of the back frame.

The present invention relates to a wheelchair, comprising a rolling chassis, particularly a motorized self-propelling chassis, on which a chair frame is mounted, which chair frame comprises a base frame which is connected to the chassis and which carries a seat cushion or on which a seat cushion is at least receivable, and a back frame for mounting of a back cushion, wherein the back frame is connected to the chair frame for adjustment relative to the chair frame, and wherein an actuator which is able and configured to impose on the back frame an adjustment relative to the base frame, particularly a reclining, is coupled to the back frame. The invention furthermore relates to a chair frame as applied or at least applicable in such a wheelchair.

A wheelchair of the above described type is for instance known from an earlier European patent application published under number EP 2.997.946. This describes a motorized wheelchair with a self-propelling chassis on which a tiltable chair frame is mounted. Arranged between the chassis and the chair frame is an actuator whereby the chair frame can be elevated from an original sitting position to a greater height and finally moved into a fully straightened, upright position. In this latter position the chair frame provides support for the user wishing to take up a standing position.

The known wheelchair realizes a conversion of the wheelchair from a low sitting position to distinct upright positions by means of a single lifting cylinder and a complex system of arms and transmissions. The range of positions which can be taken up by the known wheelchair is hereby limited, and individual displacements of the seat cushion and the back cushion are inevitably linked to each other.

The present invention has for its object, among others, to provide a wheelchair which offers more flexibility and, in possible embodiments, thereby moreover offers a wider range of operating modes.

In order to achieve the stated object a wheelchair of the type described in the preamble has the feature according to the invention that the back frame comprises a first part which is connected to the base frame and a second part which comprises the back cushion or on which the back cushion is at least receivable, that the first part and the second part of the back frame are axially adjustable relative to each other, that arranged between the first and the second part of the back frame is a first further actuator which is able and configured to impose on the second part of the back frame an axial adjustment relative to the first part, and that a control device is provided which is coupled to the first actuator and the first further actuator and is able and configured to control the first actuator and the first further actuator individually and/or in mutual dependence. In contrast to the known device, the manipulation of the base frame and the back frame are here largely uncoupled from each other and the control device provides for an individual control of the second part of the back frame relative to the first part. The position of the back cushion can thus be adjusted optimally, optionally specifically to the user, in any position of the chair frame.

In a particular embodiment the wheelchair has the feature according to the invention that the actuator is proportionally extendable and is able and configured to impose on the back frame a continuously variable angle relative to the base frame, whereby the back frame can be moved into a position varying from an at least substantially right angle relative to the base frame to a position at least substantially in line with the base frame. Both the back cushion and the back frame are here individually adjustable and adaptable to the wishes of the user. This gives the user an individually adjustable user position, and thereby an optimal comfort.

Owing to, among other things, the independent control of the back cushion, the wheelchair according to the invention can provide for a wider range of supporting positions of use. In a preferred embodiment the wheelchair according to the invention is in this respect characterized in that, at the angle to the base frame, the back frame provides a sitting position to the user and that, lying and standing in line with the base frame, the back frame provides respectively a lying position and a standing support to the user. The wheelchair thereby provides both a seat function and a lying and standing support of the user.

During use the back frame is often subjected to considerable forces in that the whole upper body of the user supports thereon and pushes off thereagainst. In order to be able to adequately absorb this load, a further preferred embodiment of the wheelchair has the feature according to the invention that the back frame comprises a linear guide with a slide which is connected thereto and is axially movable thereover, that the first and the second part of the back frame are connected to each other via the guide and the slide, and that the first further actuator is coupled operatively to the slide and is able and configured to impose on the slide a displacement over the guide.

A particularly compact and stable embodiment has here in this respect the feature that the guide is formed by a central rail and the slide comprises a carriage which rolls over the rail, particularly a bearing roller screw carriage. By thus making use of a single central guide any synchronization errors are avoided. A practical embodiment of the wheelchair according to the invention has the feature here that the guide is comprised by the first part of the back frame and the second part of the back frame is axially movable thereover.

When the sitting position is modified by a tilting mechanism and/or a lifting mechanism, it can be desirable to simultaneously adjust the position of an armrest of the wheelchair thereto for optimal support of the wheelchair user. This is for instance the case when the chair frame is moved to a lying position via an anterior tilting. During this whole movement it is deemed desirable for an armrest to remain more or less parallel to the ground, and so pivot along with the back frame. This gives the wheelchair user confidence, and they will thereby keep being supported by the armrests during the tilting. In a sitting position and upright position of the chair frame it is conversely comfortable for the armrests to be placed transversely of the back frame.

A further preferred embodiment of the wheelchair according to the invention provides such adjustable armrests and is characterized for this purpose in that an armrest device is comprised by the second part of the back frame, comprising a first armrest and a second armrest which are adjustable about a rotation axis oriented transversely of the axial adjustment of the back frame and are for this purpose operatively coupled to a second further actuator in the second part of the back frame, which second further actuator is coupled to the control device and is thereby controllable separately and/or in mutual dependence with the first actuator and the first further actuator. Each of the armrests can here be provided with its own second further actuator. A more advantageous construction is however provided by a particular embodiment of the wheelchair according to the invention, characterized in that the first armrest and the second armrest are each mounted on a support arm for rotation about a rotation axis oriented transversely of the adjustment of the back frame, and that the armrests are coupled to a shared second further actuator via a drive rod each.

A shared actuator thus provides for an adjustment of both armrests, wherein an extension of the actuator is transmitted to the two armrests by separate drive rods. A preferred embodiment of the wheelchair has the feature here according to the invention that each of the drive rods has an axially adjustable length. Owing to such an axial adjustability, an individual presetting can still be imparted to each of the armrests despite the shared control thereof by an actuator shared thereby.

For the coupling of the second further actuator to the armrests use is advantageously made of a yoke which connects the two drive rods to a drive rod of the actuator. A particular embodiment of the wheelchair according to the invention therefore has the feature that the drive rods are on one side each coupled to one of the armrests and on the other engage on a shared yoke which is driven by the second further actuator. With a view to a stable suspension of the yoke inside the back frame a further particular embodiment has the feature here that the back frame comprises a linear guide with a first slide and a second slide which are connected thereto and are axially moveable thereover, that the second part of the back frame is moveable over the guide via the first slide, that the first further actuator is coupled operatively to the first slide and is able and configured to impose a displacement over the guide on the first slide together with the second part of the back frame, that the yoke is movable over the guide via the second slide, and that the second further actuator is coupled operatively to the second slide and is able and configured to impose a displacement over the guide on the second slide together with the yoke.

Good use is here made of a guide which is already present for an axial guiding of both parts of the back frame relative to each other. In this embodiment the yoke which drives the two armrests slides over the same guide, for which purpose an additional slide is provided therefor. Use is in this case also advantageously made of a single rail as guide. For this purpose a particular embodiment of the wheelchair has the feature according to the invention that the guide is formed by a central rail and the first slide and the second slide each comprise a carriage which rolls over the rail, particularly a bearing roller screw carriage.

Besides a basic sitting position and an upright standing position, the invention also provides the option of embodying a wheelchair with a lying position. For this purpose a particular embodiment of the wheelchair has the feature according to the invention that a second actuator is arranged operatively between the chassis and the chair frame and is able and configured to impose on the chair frame an adjustment relative to the chassis, particularly a forward (posterior) tilting and/or a rearward (anterior) tilting, and that the second actuator is coupled to the control device and is thereby controllable separately and/or in mutual dependence with the first actuator and the first and second further actuator. A posterior tilting results here in an upright position of the chair frame, in which the standing user is provided with back support, while an anterior tilting initiates a lying position.

Although for the actuators per se use can be made of various actuators, such as particularly also fluid pressure-controlled cylinders, the wheelchair according to the invention particularly has the feature that a linear actuator is applied for each of the actuators, particularly an electronically driven and controllable screw spindle.

The invention also relates to the chair frame as applied or at least applicable in the above described wheelchair according to the invention and will be further elucidated hereinbelow with reference to an exemplary embodiment and an accompanying drawing. In the drawing:

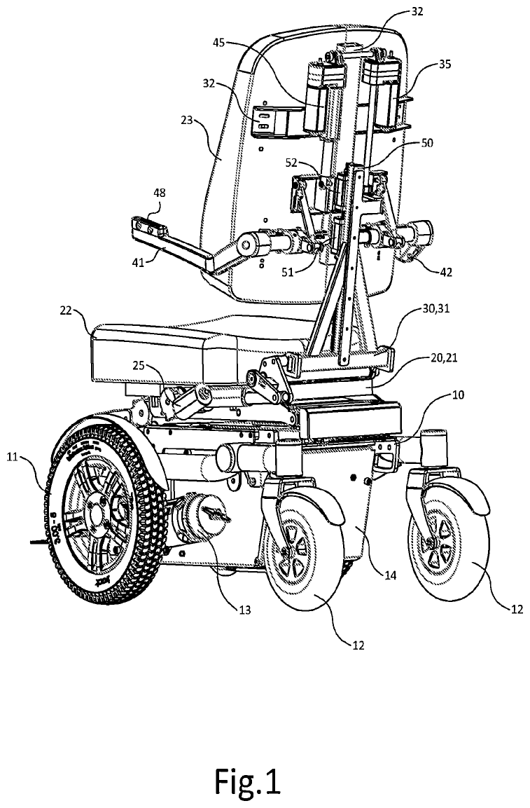

FIG. 1 is an isometric view of an exemplary embodiment of a wheelchair according to the invention;

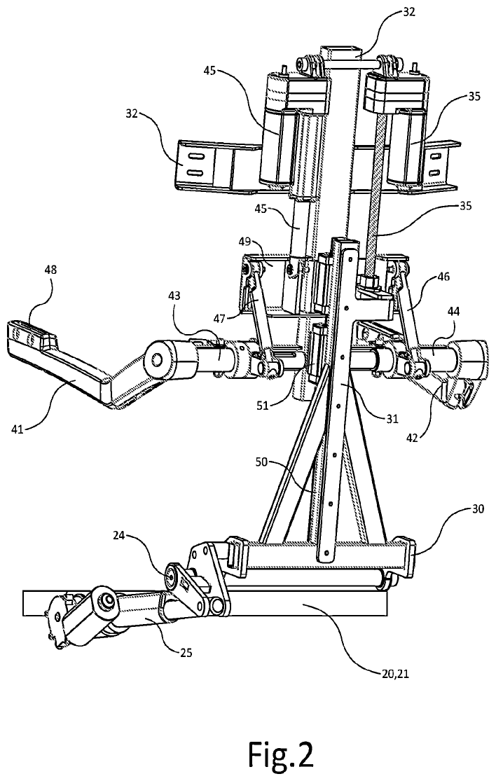

FIG. 2 is an isometric view of a chair frame as applied in the wheelchair of FIG. 1 in a first position which provides a seat function;

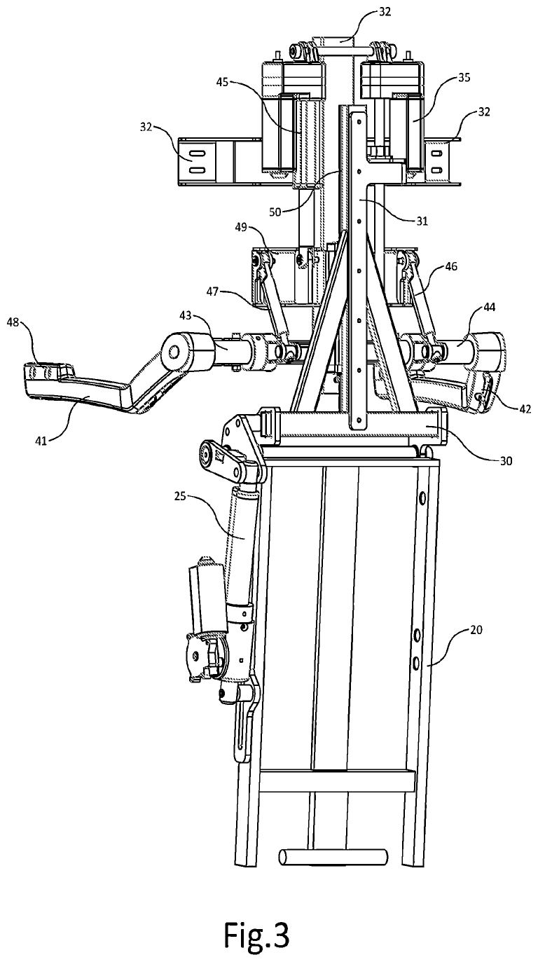

FIG. 3 is an isometric view of the chair frame as applied in the wheelchair of FIG. 1 in a second position which provides standing support;

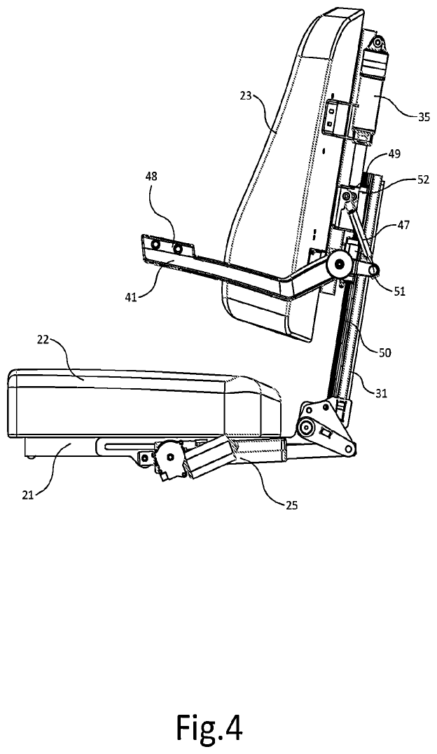

FIG. 4 is a side view of the chair frame provided with a seat cushion and a back cushion in the first position;

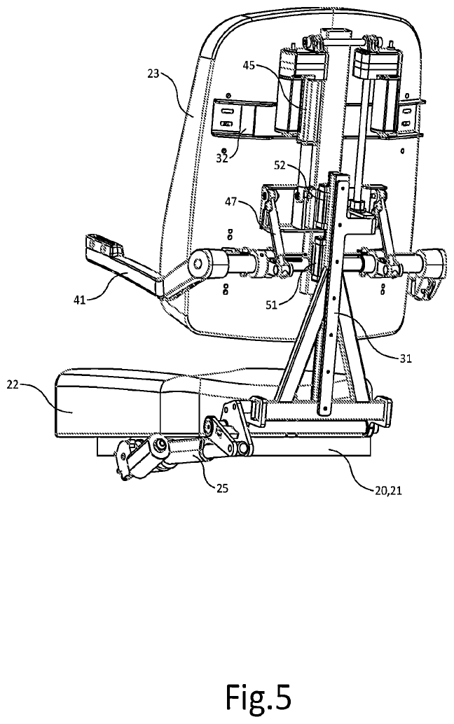

FIG. 5 is an isometric view of the chair frame provided with a seat cushion and a back cushion in the first position;

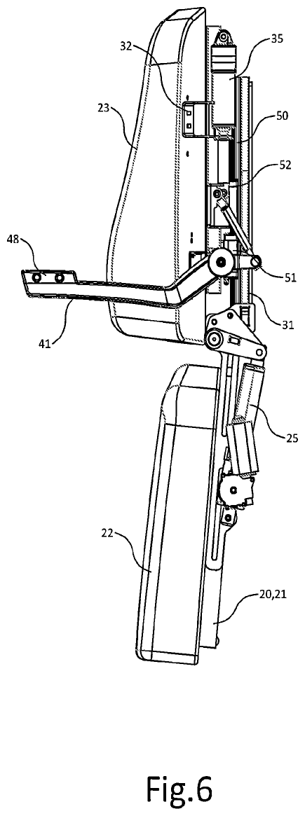

FIG. 6 is a side view of the chair frame provided with a seat cushion and a back cushion in the second position;

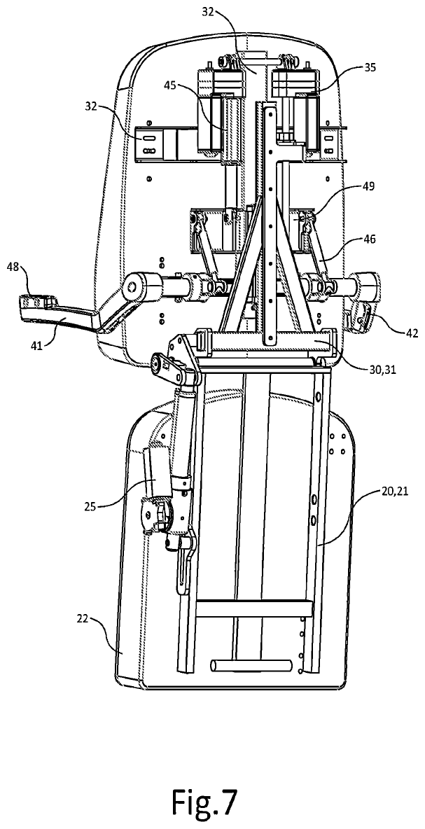

FIG. 7 is an isometric view of the chair frame provided with a seat cushion and a back cushion in the second position;

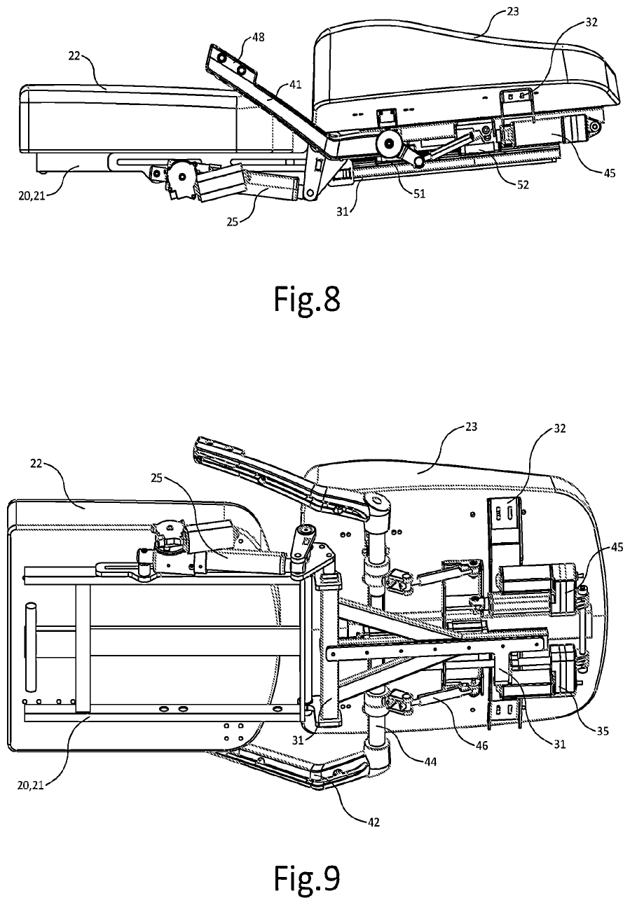

FIG. 8 is a side view of the chair frame provided with a seat cushion and a back cushion in a third position, which provides a lying function; and

FIG. 9 is an isometric view of the chair frame provided with a seat cushion and a back cushion in the third position.

It should otherwise be noted that the figures are purely schematic and not always drawn to (the same) scale. Some dimensions in particular may be exaggerated to greater or lesser extent for the sake of clarity. Corresponding parts are designated in the figures with the same reference numeral.

FIG. 1 shows an example of a wheelchair according to the invention in an isometric rear view. The wheelchair comprises a robust self-propelling motorized chassis 10 comprising two driven wheels 11 on a front side and a set of swivel wheels 12 on a rear side. The driven wheels 11 are driven directly by an electric motor 13 which is mounted thereon and which is powered by battery pack 14 accommodated in the chassis. The chassis takes a spring-mounted form in order to increase the sitting comfort and to maintain road-holding and contact with a ground surface. On an upper side the chassis carries a chair frame 20 which is shown separately in the other figures and will be further described below. The chair frame is mounted for tilting relative to the chassis about a tilt axis oriented transversely of the direction of travel on a front side and is for this purpose driven by a linear actuator, such as a pressure cylinder or, as in this case, a screw spindle, which is placed operatively between chassis 10 and chair frame 20 and is concealed from view by the chair frame in the figure. The wheelchair thereby provides, if desired, for a forward (posterior) tilting about said axis and thereby takes up an upright position in which standing support is provided.

In FIGS. 2 and 3 chair frame 20 is shown separately and comprises essentially a base frame 21 and a back frame 30 connected adjustably thereto. As described above, the base part 21 is connected to chassis 10 and carries a seat cushion 22, while a back cushion 23 is carried by back frame 30, see also FIGS. 4-9. A linear actuator 25 is mounted operatively between base part 21 and back frame 30 and is coupled to a central control device (not further shown) of the wheelchair in chassis 10 whereby an adjustment relative to the base part can be imposed on the back frame. Back frame 30 thereby pivots about a pivot shaft 24 oriented transversely of the direction of travel. FIG. 3 shows the chair frame in a fully straight position, wherein the back frame 30 is pivoted almost 90 degrees relative to the base frame 20, 21 and lies in line with base frame 20, 21. The actuator 25 is proportionally controllable, whereby the back frame can likewise take on any intermediate angle.

According to the invention, the back frame 30 comprises a first part 31 which provides for the connection to the base frame, and a second part 32 which carries the back cushion 24. Provided therebetween is a linear guide 33. In this case the guide comprises a central single rail 50 over which a slide 51 runs. For the purpose of a smooth movement of back frame 30 use is made for slide 51 of a bearing roller screw carriage which is held by rail 50 but rolls thereover in axial direction with only limited friction and in substantially clearance-free manner. The central rail 50 is permanently connected to the first part 31 of the back frame by means of screws or nails. Slide 51 carries the second part 32 of the back frame, which is thus axially adjustable relative to the first part. For this purpose a further actuator 35 is mounted operatively between the first part 31 and the second part 32 of the back frame. Use is here for this further actuator 35 also made of an electric screw spindle with a corresponding drive rod which engages on the first part 31 of the back frame. Just as all the other actuators of the wheelchair, this further actuator is also coupled to the central control device and is controllable thereby.

The second part 32 of the back frame carries an armrest device 40 with a first armrest 41 and a second armrest 42. The two armrests 41, 42 are each supported by a support arm 43, 44, about which they both pivot freely so that the armrests can if desired be folded away in upward direction. Provided internally between each of the armrests and the relevant support arm is a stop for blocking the armrests in downward direction in the shown position. The support arms 43, 44 are suspended in the second part 32 of the back frame for rotation about their central axis, and each coupled to a drive rod 46, 47 extending from a shared yoke 49. The two drive rods 46, 47 are axially adjustable and their length is thereby individually adjustable to a desired basic position of the armrest 41, 42 coupled thereto.

The two drive rods 46, 47 extend from a shared yoke 49 which is movable over guide 50 via a second bearing roller screw carriage 52. A second further actuator 45 is coupled operatively between the second part 32 of the back frame and this yoke 49, which can thereby be extended over guide 50. The drive rods 46, 47 engage eccentrically on the support arms 43, 44, which will thereby perform a rotation in the second part 32 of the back frame, carrying the armrests 41, 42 along with them. The armrests 41, 42 can thus be moved from the position shown in FIGS. 2 and 3, roughly perpendicularly of the back frame, into the position shown in FIGS. 8 and 9, wherein the armrests rather lie in line with the back frame 31, 32. This corresponds with a lying position of the chair frame, so that the armrests 41, 42 still lie roughly parallel to the bottom and roughly maintained this position during the transition of the chair from the sitting position shown in FIGS. 4 and 5 to this lying position.

One of the armrests 41 is provided with a control unit 48 whereby the user can control the wheelchair. The chair can be moved from the sitting position of FIGS. 4 and 5 into the position shown in FIGS. 6 and 7, wherein a standing support is provided. The tilt cylinder or actuator is for this purpose extended between chassis 10 and base frame 20, whereby the latter tilts forward. The first actuator 25 is here also extended, whereby back frame 30 swings about its swivel axis and back cushion 23 comes to lie more in line with seat cushion 22. The first further actuator 35 simultaneously adjusts the second part 32 of back frame 30 relative to the first part so that back cushion 23 also comes to lie closer to the seat cushion, see FIG. 6. By performing the described steps in reverse order the wheelchair can be returned to the sitting position.

In order to move the wheelchair from the sitting position shown in FIGS. 4 and 5 into the lying position of FIGS. 8 and 9 the first actuator 25 is likewise extended in order to swivel back cushion 23 away from seat cushion 22. The actuator between chassis 10 and chair frame 20 however remains retracted. Simultaneously to the adjustment of back frame 30, the second part 32 thereof is now also adjusted relative to the first part 31 by extending the first further actuator 35, so that the back cushion 23 will now also connect more closely to the seat cushion. The second further actuator 45 is here further also extended in order always to hold the armrests 41, 42 substantially parallel to the ground so as to thereby provide continuous support for the user. By performing the described steps in reverse order the wheelchair can be returned to the sitting position.

Although the invention has been further elucidated above with reference to only a single exemplary embodiment, it will be apparent that the invention is by no means limited thereto. On the contrary, many variations and embodiments are still possible within the scope of the invention for a person with ordinary skill in the art.

1. A wheelchair, comprising a rolling chassis, particularly a motorized self-propelling chassis, on which a chair frame is mounted, which chair frame comprises a base frame which is connected to the chassis and which carries a seat cushion or on which a seat cushion is at least receivable, and a back frame for mounting of a back cushion, wherein the back frame is connected to the chair frame for adjustment relative to the chair frame, and wherein an actuator which is able and configured to impose on the back frame an adjustment relative to the base frame, particularly a reclining, is coupled to the back frame, wherein the back frame comprises a first part which is connected to the base frame and a second part which comprises the back cushion or on which the back cushion is at least receivable, that the first part and the second part of the back frame are axially adjustable relative to each other, that arranged between the first and the second part of the back frame is a first further actuator which is able and configured to impose on the second part of the back frame an axial adjustment relative to the first part, and wherein a control device is provided which is coupled to the first actuator and the first further actuator and is able and configured to control the first actuator and the first further actuator individually and/or in mutual dependence.

2. The wheelchair according to claim 1, wherein the actuator is proportionally extendable and is able and configured to impose on the back frame a continuously variable angle relative to the base frame, whereby the back frame can be moved into a position varying from an at least substantially right angle relative to the base frame to a position at least substantially in line with the base frame.

3. The wheelchair according to claim 2, wherein, at the angle to the base frame, the back frame provides a sitting position to the user and wherein, lying and standing in line with the base frame, the back frame provides respectively a lying position and a standing support to the user.

4. The wheelchair according to claim 1 wherein the back frame comprises a linear guide with a slide which is connected thereto and is axially movable thereover, wherein the first and the second part of the back frame are connected to each other via the guide and the slide, and wherein the first further actuator is coupled operatively to the slide and is able and configured to impose on the slide a displacement over the guide.

5. The wheelchair according to claim 4, wherein the guide is formed by a central rail and the slide comprises a carriage which rolls over the rail, particularly a bearing roller screw carriage.

6. The wheelchair according to claim 4, wherein the guide is comprised by the first part of the back frame and the second part of the back frame is axially movable thereover.

7. The wheelchair according to claim 1, wherein an armrest device is comprised by the second part of the back frame, comprising a first armrest and a second armrest which are adjustable about a rotation axis oriented transversely of the axial adjustment of the back frame and are for this purpose operatively coupled to a second further actuator in the second part of the back frame, which second further actuator is coupled to the control device and is thereby controllable separately and/or in mutual dependence with the first actuator and the first further actuator.

8. The wheelchair according to claim 7, wherein the first armrest and the second armrest are each mounted on a support arm for rotation about a rotation axis oriented transversely of the adjustment of the back frame, and wherein the armrests are coupled to a shared second further actuator via a drive rod each.

9. The wheelchair according to claim 8, wherein each of the drive rods has an axially adjustable length.

10. The wheelchair according to claim 8, wherein the drive rods are on one side each coupled to one of the armrests and on the other engage on a shared yoke which is driven by the second further actuator.

11. The wheelchair according to claim 10, wherein the back frame comprises a linear guide with a first slide and a second slide which are connected thereto and are axially moveable thereover, wherein the second part of the back frame is moveable over the guide via the first slide, wherein the first further actuator is coupled operatively to the first slide and is able and configured to impose a displacement over the guide on the first slide together with the second part of the back frame, wherein the yoke is movable over the guide via the second slide, and wherein the second further actuator is coupled operatively to the second slide and is able and configured to impose a displacement over the guide on the second slide together with the yoke.

12. The wheelchair according to claim 11, wherein the guide is formed by a central rail and the first slide and the second slide each comprise a carriage which rolls over the rail, particularly a bearing roller screw carriage.

13. The wheelchair according to claim 1, wherein a second actuator is arranged operatively between the chassis and the chair frame and is able and configured to impose on the chair frame an adjustment relative to the chassis, particularly a forward (posterior) tilting and/or a rearward (anterior) tilting, and wherein the second actuator is coupled to the control device and is thereby controllable separately and/or in mutual dependence with the first actuator and the first and second further actuator.

14. The wheelchair according to claim 1, wherein a linear actuator is applied for each of the actuators, particularly an electronically driven and controllable screw spindle.

15. A chair frame as applied in the wheelchair according to claim 1.
